(19) United States
(12) Patent Application Publication
(10) Pub. No.: US 2019/0309792 A1
(43) Pub. Date: Oct. 10, 2019

(54) CRANKSHAFTS AND METHODS OF BALANCING THE SAME

(71) Applicant: GM GLOBAL TECHNOLOGY OPERATIONS LLC, DETROIT, MI (US)

(72) Inventors: Alessio Courtial, Torino (IT); Giuliano Sperlinga, Ottaviano (IT)

(21) Appl. No.: 15/948,041

(22) Filed: Apr. 9, 2018

(51) Int. Cl. F16C 3/20; F16C 11/02; F16C 19/50; F16F 15/28; F16F 15/32

(52) U.S. Cl. CPC F16C 3/20; F16C 11/02; F16F 15/322; F16F 15/283; F16C 19/507

(57) ABSTRACT

Provided herein are crankshafts comprising a first and second bearing journal both aligned along a crankshaft rotation axis, a first counterweight throw, a web throw including a first web and a second web coupled via a second crankpin, wherein the first web is coupled to the first counterweight throw via the first bearing journal, and a second counterweight throw coupled to the second web via the second bearing journal. The first web and second web each have a center of gravity (COG) offset from a plane defined by the crankshaft rotation axis and a longitudinal axis of the second crankpin. The COGs of each web can be on opposite sides of a plane defined by the crankshaft rotation axis and a longitudinal axis of the second crankpin. The COGs of each web can be substantially symmetrical relative to the plane.

Internal combustion engines include at least one crankshaft. A crankshaft converts reciprocating linear movement of a piston into rotational movement about a crankshaft axis to provide torque to propel a vehicle, such as but not limited to a train, a boat, a plane, or an automobile, or to drive any other apparatus powered by the engine.

The crankshaft includes at least one crankpin that is offset from the crankshaft axis, to which a reciprocating piston is attached via a connecting rod. Force applied from the piston to the crankshaft through the offset connection therebetween generates torque in the crankshaft, which rotates the crankshaft about the crankshaft axis. The crankshaft further includes at least one main bearing journal disposed concentrically about the crankshaft axis. The crankshaft is secured to an engine block at the main bearing journals. A bearing is disposed about the main bearing journal, between the crankshaft and the engine block.

### SUMMARY

A crankshaft is provided, and includes a first bearing journal and a second bearing journal, both aligned along a crankshaft rotation axis, a first counterweight throw including a first throw arm coupled to a second throw arm via a first crankpin, a web throw including a first web and a second web coupled via a second crankpin, wherein the first web is coupled to the second throw arm of the first counterweight throw via the first bearing journal, and a second counterweight throw including a first throw arm connected to a second throw arm via a third crankpin, wherein the first throw arm is connected to the second web via the second bearing journal. The first web and second web can each have a center of gravity (COG) on opposite sides of a plane defined by the crankshaft rotation axis and a longitudinal axis of the second crankpin. The COG of the first web and the second web can each occur within the radial cross-sectional area of the second crankpin. The COG of the first web and the second web can each occur outside of the radial cross-sectional area of the second crankpin. The first web and/or second web can include one or more COG-offsetting holes. The COGs of the first web and second web can be substantially symmetrical relative to the plane defined by the crankshaft rotation axis and a longitudinal axis of the second crankpin. Each of the first, second, and third crankpins can have a generally cylindrical body with a longitudinal axis offset from, but parallel to, the crankshaft rotation axis. One or more of the first web and second web can each include two asymmetric, COG-offsetting corners on opposite sides of the plane defined by the crankshaft rotation axis and a longitudinal axis of the second crankpin. The two asymmetric, COG-offsetting corners of the first web can form a contour which is asymmetrically mirrored by a contour formed by the two asymmetric, COG-offsetting corners of the second web, relative to the plane defined by the crankshaft rotation axis and a longitudinal axis of the second crankpin. The crankshaft rotation axis, the plane defined by the crankshaft rotation axis and a longitudinal axis of the second crankpin, and each of the COG of the first web and the COG of the second web can define a COG offset angle of about 5 degrees to about 15 degrees for each of the first web and the second web, respectively.

A crankshaft is provided, and includes a first bearing journal and a second bearing journal, both aligned along a crankshaft rotation axis, a first counterweight throw, a web throw including a first web and a second web coupled via a crankpin, wherein the first web is coupled to the first counterweight throw via the first bearing journal, and a second counterweight throw coupled to the second web via the second bearing journal. The first web and second web each have a center of gravity (COG) offset from a plane defined by the crankshaft rotation axis and a longitudinal axis of the crankpin. The COG of the first web and the second web can each occur within the radial cross-sectional area of the crankpin. The COG of the first web and the second web can each occur outside of the radial cross-sectional area of the crankpin. The first web and/or second web can include one or more COG-offsetting holes. The COGs of the first web and second web can be on opposite sides of a plane defined by the crankshaft rotation axis and a longitudinal axis of the crankpin. The COGs of the first web and second web can be substantially symmetrical relative to the plane defined by the crankshaft rotation axis and a longitudinal axis of the crankpin. The crankpin can have a generally cylindrical body with a longitudinal axis offset from, but parallel to, the crankshaft rotation axis. One or more of the first web and second web can each include two asymmetric, COG-offsetting corners on opposite sides of the plane defined by the crankshaft rotation axis and a longitudinal axis of the crankpin. The two asymmetric, COG-offsetting corners of the first web can form a contour which is asymmetrically mirrored by a contour formed by the two asymmetric, COG-offsetting corners of the second web, relative to the plane defined by the crankshaft rotation axis and a longitudinal axis of the crankpin. The crankshaft rotation axis, the plane defined by the crankshaft rotation axis and a longitudinal axis of the crankpin, and each of the COG of the first web and the COG of the second web can define a COG offset angle of about 5 degrees to about 15 degrees for each of the first web and the second web, respectively.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic view of an automotive system, according to one or more embodiments;

FIG. 2 illustrates a cross-sectional view of an internal combustion engine, according to one or more embodiments;

FIG. 3 illustrates a perspective view of a crankshaft, according to one or more embodiments;

FIG. 4 illustrates a perspective view of a crankshaft coupled to connecting rods, according to one or more embodiments;

FIG. 5 illustrates a cross-sectional sideview of a crankshaft, according to one or more embodiments;

FIG. 6A illustrates a cross-sectional side view of a crankshaft, according to one or more embodiments; and

FIG. 6B illustrates a cross-sectional side view of a crankshaft, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

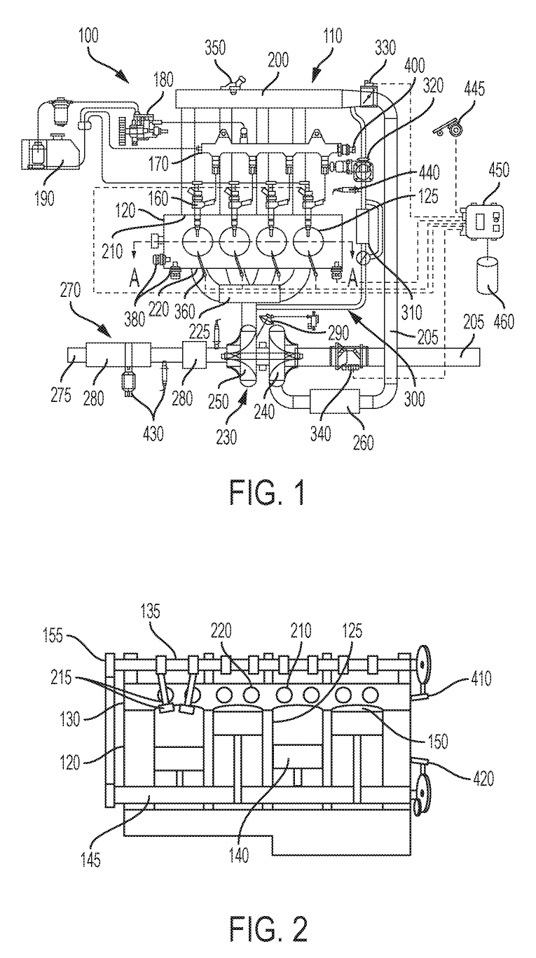

Many embodiments of crankshafts provided herein may relate to an automotive system 100, as shown in FIGS. 1 and 2, which includes several elements for the purpose of illustration only. System 100 can, for example, include an internal combustion engine (ICE) 110 having an engine block 120 defining at least one cylinder 125 having a piston 140 coupled to rotate a crankshaft 145. Engine block 120 is shown comprising four cylinders 125, but in many embodiments, the engine block 120 defines three cylinders 125. Although many of the embodiments herein are described in relation to crankshafts used for three-cylinder ICEs, the embodiments herein are generally suitable for ICEs having any odd number of cylinders (e.g., 5 cylinders).

A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high-pressure fuel pump 180 that increase the pressure of the fuel received from a fuel source 190. Each of the cylinders 125 has at least two valves 215, actuated by the camshaft 135 rotating in time with the crankshaft 145. The valves 215 selectively allow air into the combustion chamber 150from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel pump 180, fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system 460, or data carrier, and an interface bus. The CPU is configured to execute instructions stored as a program in the memory system, and send and receive signals to/from the interface bus. The memory system 460 may include various storage types including optical storage, magnetic storage, solid state storage, and other non-volatile memory. The interface bus may be configured to send, receive, and modulate analog and/or digital signals to/from the various sensors and control devices.

Instead of an ECU 450, the automotive system 100 may have a different type of processor to provide the electronic logic, e.g. an embedded controller, an onboard computer, or any processing module that might be deployed in the vehicle.

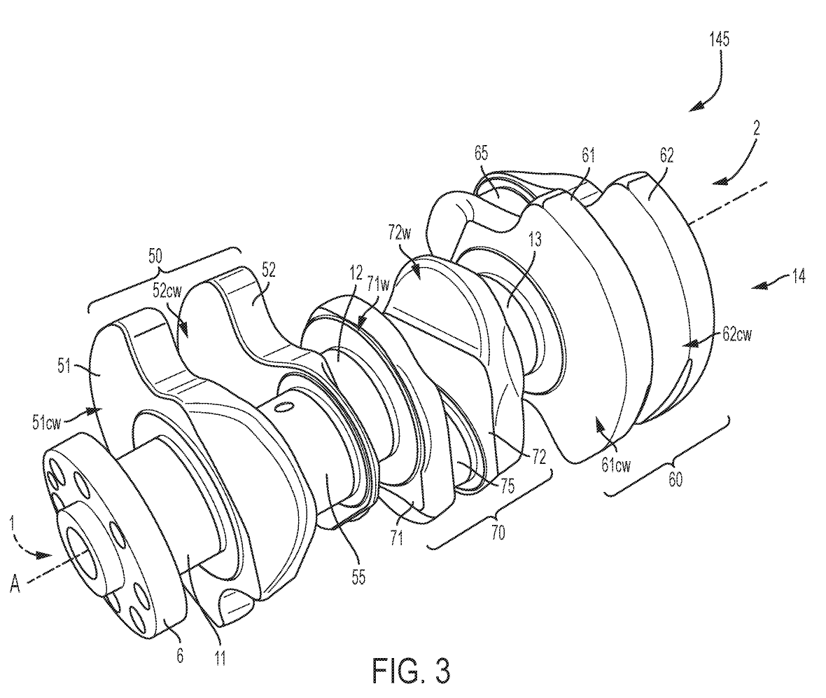

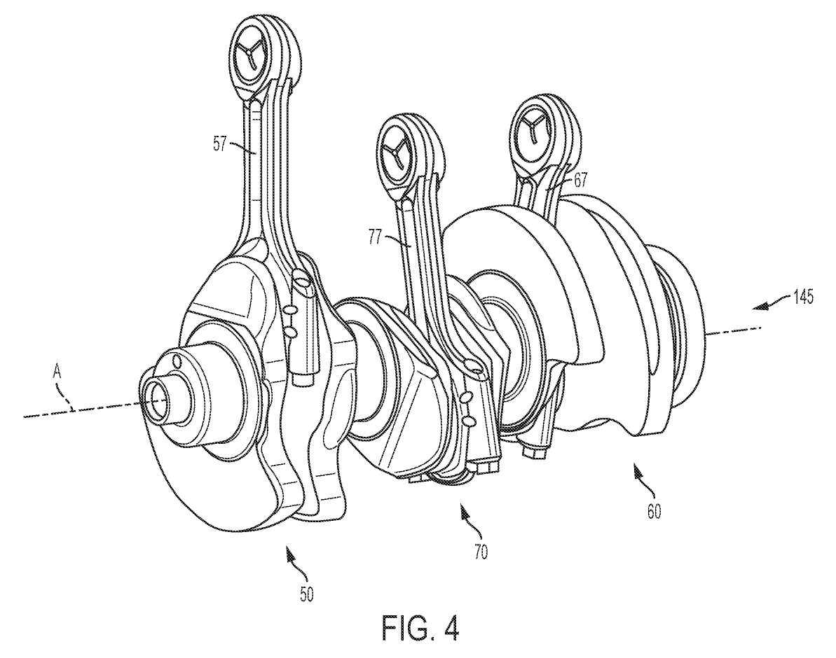

FIG. 3 illustrates an engine crankshaft 145 defined by a rotation axis A and including a first counterweight throw 50, a second counterweight throw 60, and a web throw 70 disposed between the first and second counterweight throws 50,60. A first bearing journal 11 is coupled to the first counterweight throw 50 proximate the first terminal end 1 of the crankshaft 145. First bearing journal 11 may be further coupled to a component of the appurtenant engine or vehicle, such as flange 6, for example. A second bearing journal 12 couples the first counterweight throw 50 to the web throw 70, and a third bearing journal 13 couples the web throw 70 to the second counterweight throw 60. A fourth bearing journal 14 (obscured by the second counterweight throw 60) can couple to the second counterweight throw 60 at a second terminal end 2 of the crankshaft 145. Each of the bearing journals 11-14 conform to the rotation axis A.

The first counterweight throw 50 comprises a first throw arm 51 and a second throw arm 52 which are each generally planar bodies disposed normal to the axis A. A “generally planar body” is one which extends radially outward from the rotation axis A in most directions, and does not preclude the inclusion of irregular features such as protrusions, holes, apertures, or casting or forging drafts, among other features. First throw arm 51 and second throw arm 52 are coupled via a first crankpin 55 which is a generally cylindrical body having a longitudinal axis offset from, but parallel to, rotation axis A. The first bearing journal 11 couples to a central portion of the first throw arm 51, separating the point of attachment of the first crankpin 55 at one end of the first throw arm 51 from a counterweight body portion 51CW at a generally opposite end of the first throw arm 51. The second bearing journal 12 couples to a central portion of the second throw arm 52, separating the point of attachment of the first crankpin 55 at one end of the second throw arm 52 from a counterweight body portion 52CW at a generally opposite end of the first throw arm 52.

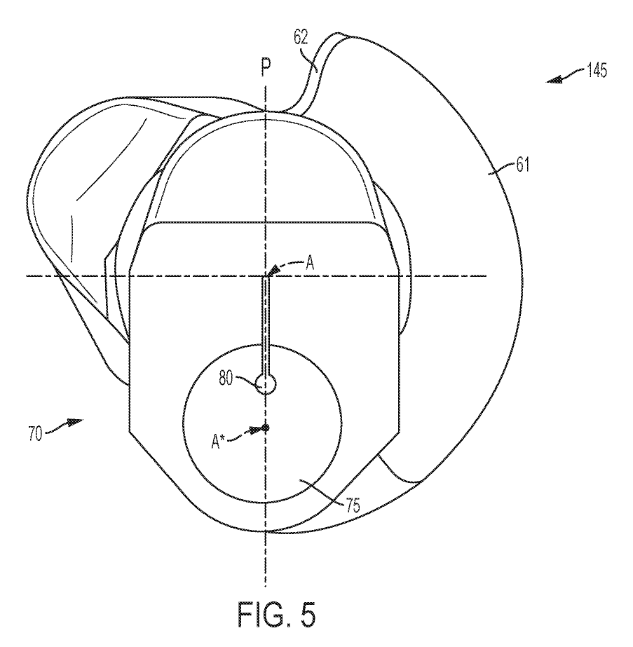

The second counterweight throw 60 comprises a first throw arm 61 and a second throw arm 62 which are each generally planar bodies disposed normal to the axis A. First throw arm 61 and second throw arm 62 are coupled via a third crankpin 65 which is a generally cylindrical body having a longitudinal axis offset from, but parallel to, rotation axis A. The third bearing journal 13 couples to a central portion of the first throw arm 61, separating the point of attachment of the third crankpin 65 at one end of the first throw arm 61 from a counterweight body portion 61CW at a generally opposite end of the first throw arm 61. The fourth bearing journal 14 (obscured) couples to a central portion of the second throw arm 62, separating the point of attachment of the third crankpin 65 at one end of the second throw arm 62 from a counterweight body portion 62CW at a generally opposite end of the first throw arm 62. The counterweight body portions of a given throw arm provide an eccentric center of gravity (COG) which deviates from the rotation axis A. Such eccentric COG is generally disposed opposite to the counterweight throw crankpin, relative to the rotation axis A. For example, the eccentric COGs of the first counterweight throw 50 and the second counterweight throw 60 are generally oriented 90 degrees relative to plane P (FIG. 5). As the crankshaft 145 rotates, the counterweight throws (e.g., counterweight throws 50 and 60) impart centrifugal loads which are tuned to balance the crankshaft 145. In particular, imparted centrifugal loads are designed to minimize or eliminate the aggregate centrifugal load imparted to the crankshaft 145 by each aspect of the crankshaft which comprises an eccentric COG.

The web throw 70 comprises a first web 71 and a second web 72 which are each generally planar bodies disposed normal to the axis A. First web 71 and second web 72 are coupled via a second crankpin 75 which is a generally cylindrical body having a longitudinal axis offset from, but parallel to, rotation axis A. The second bearing journal 12 couples to a central portion of the first web 71, separating the point of attachment of the second crankpin 75 at one end of the first web 71 from a web portion 71W at a generally opposite end of the first web 71. The third bearing journal 13 couples to a central portion of the second web 72, separating the point of attachment of the second crankpin 75 at one end of the second web 72 from a web portion 72W at a generally opposite end of the second web 72. The planar shapes of the web throw 70 and first and second counterweight throws 60,70 are non-circular, and therefore have varying radii. The web throw 70 is distinct from the first and second counterweight throws 60,70 in that its planar webs 71,72 have a lower average radius and/or maximum radius than the throw arms 51, 52, 61, 62.

From a perspective normal to the axis A, axis A and the respective longitudinal axes of a pair of adjacent crankpins (e.g., 55 and 75, or 65 and 75) define a crank throw angle of 120°. Thus, the crankpins are equally arranged around the rotation axis A to provided optimal combustion timing and sequence to the cylinders 125 of ICE 110. The spacing of the crankpins 55, 65, and 75 along axis A will accommodate the configurations taken by cylinders 125 of ICE 110. For example, three cylinders 125 of ICE 110 can be evenly spaced, and the appurtenant crankpins 55, 65, and 75 will similarly be evenly spaced along axis. The respective crankpins (i.e., 55, 65, 75) of the first counterweight throw 50, the second counterweight throw 60, and the web throw 70 translate reciprocating motion of the cylinders 125 of ICE 110 to rotational energy of the crankshaft 145 via a commonly associated connecting rod. FIG. 4 illustrates connecting rods 57, 67, and 77 coupled to respective crankpins 55, 65, 75. As shown, the connecting rods 57, 67, and 77 may rotatably couple to the respective crankpins 55, 65, 75 by virtue of a geometry which surrounds the latter.

The first counterweight throw 50 and the second counterweight throw 60, the counterweight body portions thereof (i.e., 51CW and 52CW, and 61CW and 62CW, respectively) in particular, are designed to collaboratively balance the rotation of the crankshaft 145 about the axis A to reduce vibration therein. The throw arms and counterweight body portions thereof can be fashioned from various suitable materials, including metals such as steel and aluminum. The same may include features such as high-density material slugs (e.g., tungsten slugs), at least partially disposed inside the throw arm, to achieve desired balancing. FIG. 5 illustrates a cross-sectional sideview of the crankshaft 145. The web throw 70 is shown to have a COG 80 which is aligned on a plane P defined by the rotation axis A and the longitudinal axis A* of the crankpin 75. The COG of both first web 71 and second web 72 are substantially identical to the COG 80 of the web throw 70.

Crankshafts are typically balanced by adding/subtracting weight from the counter weights (e.g., first counterweight throw 50 and/or second counterweight throw 60), as the middle web throw is generally symmetric and provides little, if any, balancing centrifugal forces. However, crankshaft design can be constrained by vehicle mass constraints and/or the overall packaging of an engine system (e.g., a crankcase of system 100) such that desired crankshaft balancing cannot be achieved. Accordingly, provided herein are balanced crankshafts comprising offset, non-symmetric planar webs 71, 72. Similarly, a method for balancing a crankshaft 145 can comprise offsetting the planar webs 71, 72 as described below. Further, the crankshafts and methods provided herein can advantageously achieve a balancing effect by maintaining the weight of a crankshaft or reducing the weight of the crankshaft, without adding weight detrimental to the performance of an engine or vehicle.

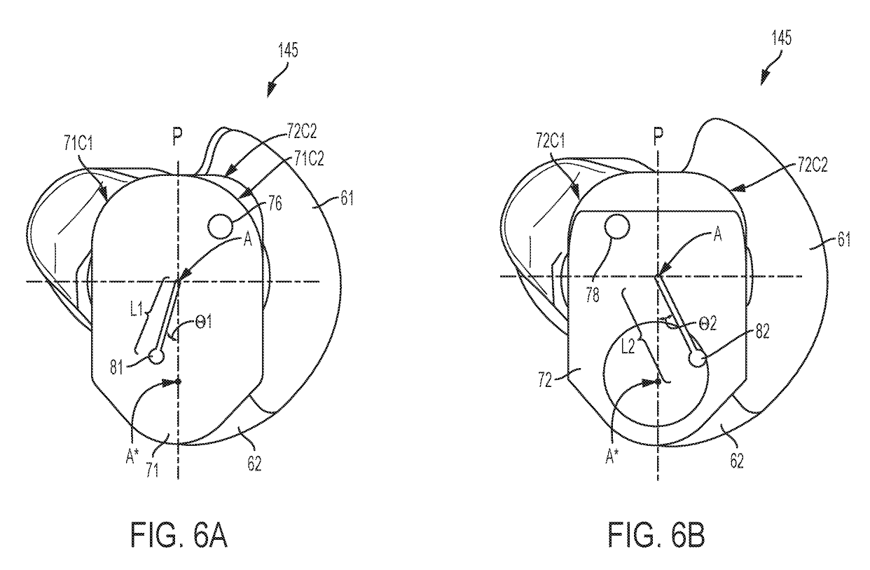

FIG. 6A illustrates a cross-sectional side view of the crankshaft 145, particularly showing first web 71, and FIG. 6b illustrates a cross-sectional side view of the crankshaft 145, particularly showing second web 72. First web 71 has a COG 81 and second web 72 has a COG 82. COGs 81 and 82 are each offset from the plane P, such that the web throw 70 and crankshaft 145 are balanced. For example, COGs 81 and 82 can each occur on opposite sides of the plane P, such that the web throw 70 and crankshaft 145 are balanced. Accordingly, eccentric COGs 81 and 82 cooperatively balance crankshaft 145 with the eccentric COGs of the first counterweight throw 50 and the second counterweight throw 60 by providing additional, balancing centrifugal forces. The extent of the offset from plane P by COGs 81 and 82 can be measured by lengths L1 and L2, which are measured from axis A and COGs 81 and 82, respectively. The extent of the offset from plane P by COGs 81 and 82 can additionally or alternatively be measured by angles θ1 and θ2, measured between plane P and lengths L1 and L2, respectively. In some embodiments, angles θ1 and θ2 can be about 5 degrees to about 15 degrees. Lengths L1 and L2 are determined based upon angles θ1 and θ2 and the extent of balancing force required. For example, a required balancing force can comprise a crankshaft balancing force deficiency which the counterweight throws 50 and 60 are unable to provide.

COGs 81 and 82 can be substantially symmetrical, relative to the plane P, in some embodiments (i.e., L1 equals L2 and angles θ1 and θ2 have equal magnitudes). COGs 81 and/or 82 can occur within the radial cross-sectional area of crankpin 75 (e.g., as shown in FIG. 6B). In other embodiments, COGs 81 and/or 82 can occur outside of the radial cross-sectional area of crankpin 75 (i.e., have greater angles of deviation, θ1 and θ2, from plane P). In some embodiments, COGs 81 and 82 are offset from plane P without adding mass to web throw 70. In some embodiments, COGs 81 and 82 are offset from plane P by removing mass from web throw 70. In some embodiments, COGs 81 and/or 82 can be offset from plane P by removing mass from a region of each web, such as via one or more holes 76 and 78 of first web 71 and second web 72, respectively. Holes 76 and 78 can be of varying shapes and depths, and may partially or fully extend through its respective web.

In some embodiments, COGs 81 and 82 are offset from plane P by altering one or more perimeter contours of first web 71 and second web 72, respectively. Generally, first web 71 comprises a first web corner 71C1 and a second web corner 71C2, and second web 72 comprises a first web corner 72C1 and a second web corner 72C2. Each of the two corners 71C1 and 71C2, and 72C1 and 72C2 generally define an upper contour for each web 71 and 72, respectively. As used herein, “corners” refers generally to regions of each web, such as regions on opposite sides of plane P. One or more corners of each web can be asymmetric in order to offset the COG. In some embodiments, the upper contour of each web 71 and 72 are altered to form an asymmetric web which asymmetrically mirrors the contour of the other web. For example, first web 71 can have a first web corner 71C1 with a smaller radius than the second web corner 71C2, and second web 72 can have a first web corner 72C1 with a larger radius than the second web corner 72C2. In some embodiments, the asymmetrically mirroring corners of the first web 71 and second web 72 may not identically mirror the corresponding corner of the other web on the opposite side of plane P, particularly when the first web 71 and the second web 72 do not comprise identical masses and/or when a COG of one web is offset using a feature not present in the other web. For example, first web 71 may comprises a hole 76 while second web 72 may not comprise a hole, accordingly one or more asymmetrically mirroring corners of first web 71 and second web 72 may generally, but not identically, be mirrored.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

hat is claimed is:

1. A crankshaft, comprising:
a first bearing journal and a second bearing journal, both aligned along a crankshaft rotation axis;
a first counterweight throw including a first throw arm coupled to a second throw arm via a first crankpin,
a web throw including a first web and a second web coupled via a second crankpin, wherein the first web is coupled to the second throw arm of the first counterweight throw via the first bearing journal; and
a second counterweight throw including a first throw arm connected to a second throw arm via a third crankpin, wherein the first throw arm is connected to the second web via the second bearing journal,
wherein the first web and second web each have a center of gravity (COG) on opposite sides of a plane defined by the crankshaft rotation axis and a longitudinal axis of the second crankpin.

2. The crankshaft of claim 1, wherein the COG of the first web and the second web each occur within the radial cross-sectional area of the second crankpin.

3. The crankshaft of claim 1, wherein the COG of the first web and the second web each occur outside of the radial cross-sectional area of the second crankpin.

4. The crankshaft of claim 1, wherein the first web and/or the second web comprise one or more COG-offsetting holes.

5. The crankshaft of claim 1, wherein the COGs of the first web and second web are substantially symmetrical relative to the plane defined by the crankshaft rotation axis and a longitudinal axis of the second crankpin.

6. The crankshaft of claim 1, wherein each of the first, second, and third crankpins comprise a generally cylindrical body with a longitudinal axis offset from, but parallel to, the crankshaft rotation axis.

7. The crankshaft of claim 1, wherein one or more of the first web and second web each comprises two asymmetric, COG-offsetting corners on opposite sides of the plane defined by the crankshaft rotation axis and a longitudinal axis of the second crankpin.

8. The crankshaft of claim 1, wherein the two asymmetric, COG-offsetting corners of the first web form a contour which is asymmetrically mirrored by a contour formed by the two asymmetric, COG-offsetting corners of the second web, relative to the plane defined by the crankshaft rotation axis and a longitudinal axis of the second crankpin.

9. The crankshaft of claim 1, wherein the crankshaft rotation axis, the plane defined by the crankshaft rotation axis and a longitudinal axis of the second crankpin, and each of the COG of the first web and the COG of the second web define a COG offset angle of about 5 degrees to about 15 degrees for each of the first web and the second web, respectively.

10. A crankshaft, comprising:
a first bearing journal and a second bearing journal, both aligned along a crankshaft rotation axis;
a first counterweight throw;
a web throw including a first web and a second web coupled via a crankpin, wherein the first web is coupled to the first counterweight throw via the first bearing journal; and
a second counterweight throw coupled to the second web via the second bearing journal,
wherein the first web and second web each have a center of gravity (COG) offset from a plane defined by the crankshaft rotation axis and a longitudinal axis of the crankpin.

11. The crankshaft of claim 10, wherein the COG of the first web and the second web each occur within the radial cross-sectional area of the crankpin.

12. The crankshaft of claim 10, wherein the COG of the first web and the second web each occur outside of the radial cross-sectional area of the crankpin.

13. The crankshaft of claim 10, wherein the first web and/or the second web comprise one or more COG-offsetting holes.

14. The crankshaft of claim 10, wherein the COGs of the first web and second web are on opposite sides of a plane defined by the crankshaft rotation axis and a longitudinal axis of the crankpin.

15. The crankshaft of claim 14, wherein the COGs of the first web and second web are substantially symmetrical relative to the plane defined by the crankshaft rotation axis and a longitudinal axis of the crankpin.

16. The crankshaft of claim 10, wherein the crankpin comprises a generally cylindrical body with a longitudinal axis offset from, but parallel to, the crankshaft rotation axis.

17. The crankshaft of claim 10, wherein one or more of the first web and second web each comprises two asymmetric, COG-offsetting corners on opposite sides of the plane defined by the crankshaft rotation axis and a longitudinal axis of the crankpin.

18. The crankshaft of claim 10, wherein the two asymmetric, COG-offsetting corners of the first web form a contour which is asymmetrically mirrored by a contour formed by the two asymmetric, COG-offsetting corners of the second web, relative to the plane defined by the crankshaft rotation axis and a longitudinal axis of the crankpin.

19. The crankshaft of claim 10, wherein the crankshaft rotation axis, the plane defined by the crankshaft rotation axis and a longitudinal axis of the crankpin, and each of the COG of the first web and the COG of the second web define a COG offset angle of about 5 degrees to about 15 degrees for each of the first web and the second web, respectively.
